(19) United States
(12) Patent Application Publication
(10) Pub. No.: US 2006/0085487 A1
(43) Pub. Date: Apr. 20, 2006

(54) Computer for storage device and method of control for storage device

(76) Inventors: Junichi Hara, Yokohama (JP); Yoji Nakatani, Yokohama (JP); Takahiro Nakano, Yokohama (JP); Yohsuke Ishii, Yokohama (JP)

Correspondence Address: Mattingly, Stanger & Malur, P.C., Suite 370, 1800 Diagonal Road, Alexandria, VA, 22314, US

(21) Appl. No.: 10/986,379

(22) Filed: Nov. 12, 2004

(30) Foreign Application Priority Data
Sep. 24, 2004 (JP) 2004-277048

(51) Int. Cl. G06F 17/30

(52) U.S. Cl. 707/200

(57) ABSTRACT

When CPU 11 receives a request to write to a file stored in a storage device 10 from client computers 30 through 32, it references the object control table of the subject file, and confirms the WORM attribute of the subject file. The CPU 11 references the WORM range control table, and determines whether or not the write subject range is set to a WORM range. When the write subject range is not set to a WORM range, the CPU 11 executes write to the subject file. When WORM form is set for write data, the CPU 11 updates the WORM range control table and sets WORM form for the written data.

### CROSS-REFERENCE TO RELATED APPLICATIONS

This application relates to and claims priority from Japanese Patent Application No. 2004-277048, filed on Sep. 24, 2004, the entire disclosure of which is incorporated by reference.

### BACKGROUND

The present invention relates to a disk array device equipped with a plurality of disk devices and a method of controlling a disk array device.

In recent years, there is demand that for data that is stored in storage array devices, maintenance of the contents of the data be guaranteed over long periods. For example, technology is known that puts into WORM form (Write-Once, Read-Many) files using file units (see “WORM Storage on Magnetic Disks Using Snaplock Compliance and SnapLock Enterprise,” Network Appliance Technical Report [TR3263] September 2003, http://www.netapp.com/tech library/3263.html, for example).

However, with prior art technology for committing data to WORM state, for newly created files and files being appended, it was not possible to commit data to WORM state until all data write was completed and the file contents were fixed. Therefore, for files for which the file contents are not fixed, for example files in the middle of being written, there was the problem of not being able to guarantee the data. In other words, as with log files, with a file for which appending is continuously executed for one file, there was the problem that data could not be protected by committing data to WORM state.

Also, it was necessary to control whether or not to commit files to WORM state using volume units, so there was the problem that ease of use was poor. Furthermore, with the prior art technology for committing data to WORM state, it was necessary to determine whether to commit the entire file to WORM state or not, so there was the problem that it was not possible to commit a portion of the data of a file to WORM state.

Therefore, there is need to solve the aforementioned problems, to protect data of a file while allowing appending to a file, or to make it possible to protect data for a specified range of the file.

The first aspect of the present invention for solving the aforementioned problems provides a computer that controls access to files stored in a storage device. The computer of the first aspect of the present invention comprises an attribute information acquisition module that, when there is a request to write data to said file that is stored in said storage device, acquires attribute information that contains at least information regarding the change prohibited range that shows the range for which changes to a file are not allowed, which is information which is associated with said file, a determination module that determines whether or not the subject range of writing data to said file is a range outside said change prohibited range by referencing said acquired attribute information, and an access control module that, when it is determined that the subject range of writing data to said file is contained in said change prohibited range, does not execute writing of data to said file.

With the computer of the first aspect of the present invention, a determination is made of whether or not the subject range of writing data to said file is a range outside said change prohibited range, and when it is determined that the subject range of writing data to said file is contained in said change prohibited range, writing of data to said file is not executed, so it is possible to protect data for a specified range of a file.

It is also acceptable to have the computer of the first aspect of the present invention such that it further comprises an appending determination module that determines whether a request to write data to said file is an appending request, wherein said attribute information further contains appending permission information that shows whether or not appending of data to a file is permitted, and said access control module, when it is determined that the a request to write data to said file is an appending request, and that the subject range of writing data to said file is not contained in said change prohibited range, and further when said appending permission information of said file shows that appending to said file is permitted, executes appending of data to said file.

By providing this structure, it is possible to protect file data while allowing appending to a file.

The second aspect of the present invention provides a computer that controls access to a storage device. The second aspect of the present invention comprises a file creation module that creates files in said storage device, a data writing module that writes data to said created file, and a setting module that, for each data write to said file, sets change prohibition so that data is not allowed to be changed for said written data storage position for said file.

With the computer of the second aspect of the present invention, it is possible to protect file data while allowing appending to the file, and to protect data for a specified range of a file.

The third aspect of the present invention provides a computer that controls access to a storage device. The computer of the third aspect of the present invention comprises a file creation module that creates at said storage device a file that is composed of one or a plurality of data and that has said one or plurality of data storage position information for said storage device as well as identification information for said storage device, a storage unit that stores attribute information that is information correlated to said file and that contains at least change prohibition information that shows said data storage positions for which change is not allowed for the file, a receiving module that receives access request commands for said storage device, a command determination module that determines whether or not said received access request command is a request to write data to said storage device, a storage position determination module that, when said received access request command is a request to write data to said storage device, specifies a file to be subject to data write using said identification information, acquires said attribute information from said storage unit, and determines whether or not the data write position in relation to said file overlaps with said storage position that is contained in said change prohibited information, and an access control module that, when it is determined that the data write position in relation to said file overlaps said storage position contained in said change prohibited information, does not execute data write to said file.

With the computer of the third aspect of the present invention, it is possible to protect data in a specified range of a file.

The computer of the first to third aspects of the present invention can also be realized in addition to this way as a method for controlling storage devices, a storage device administration control program, or as a recording medium which can be read by a computer on which the storage device administration control program is recorded.

### BRIEF DESCRIPTION OF THE DRAWINGS

FIG. 1 is an explanatory diagram that shows the schematic structure of a storage system that contains the computer of the first embodiment.

FIG. 2 is an explanatory diagram that shows a module that is stored in memory that is provided with the computer of the first embodiment.

FIG. 3 is an explanatory diagram that shows an example of object control table for files Tb1f.

FIG. 4 is an explanatory diagram that shows the correlation of WORM attribute combinations and the possible file operations.

FIG. 5 is an explanatory diagram that shows an example of WORM range control table Tb2.

FIG. 6 is an explanatory diagram that shows an example of object control table for directories Tb1d.

FIG. 7 is an explanatory diagram that shows the correlation of WORM attribute combinations and the possible directory operations.

FIG. 8 is an explanatory diagram that shows an example of the logic structure of a file system.

FIG. 9 is a flow chart that shows the process routine of data write processing executed by the computer 10 of the first embodiment.

FIG. 10 is a flow chart that shows the process routine of new file opening processing that is executed by computer 10 of the first embodiment.

FIG. 11 is a flow chart that shows the process routine of WORM attribute setting processing that is executed by computer 10 of the first embodiment.

FIG. 12 is a flow chart that shows the process routine of WORM attribute cancellation processing that is executed by computer 10 of the first embodiment.

FIG. 13 is a flow chart that shows the process routine of WORM retention period setting processing that is executed by computer 10 of the first embodiment.

FIG. 14 is an explanatory diagram that shows the schematic structure of a storage system that includes the computer of the second embodiment.

### DETAILED DESCRIPTION OF THE PREFERED EMBODIMENTS

Following, we will explain the computer and storage device control method of the present invention based on several embodiments while referring to the figures.

### First Embodiment

System Configuration:

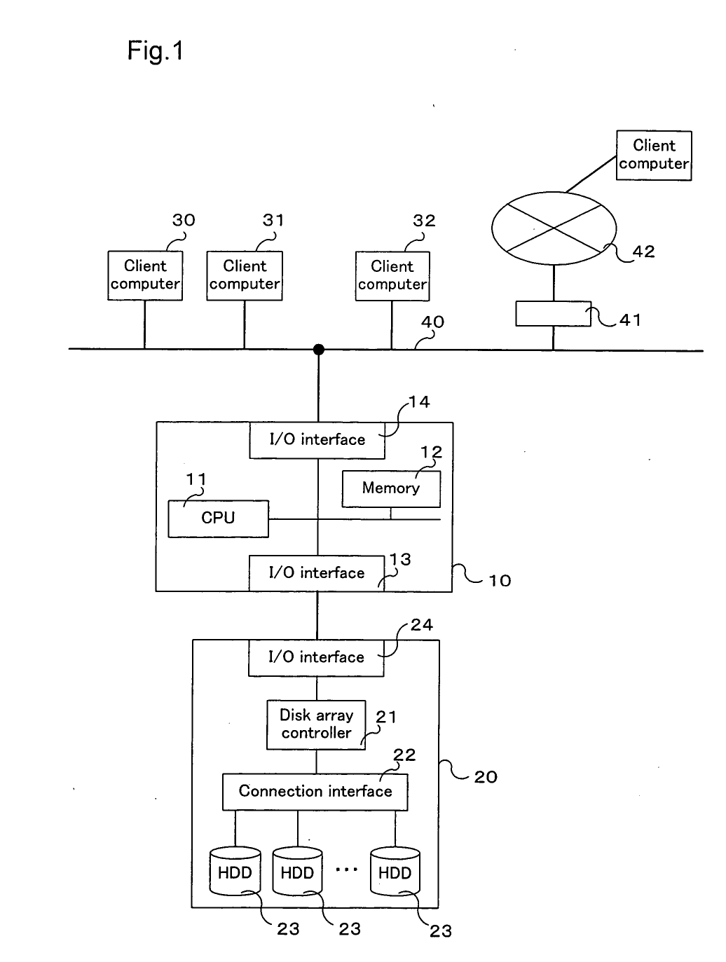

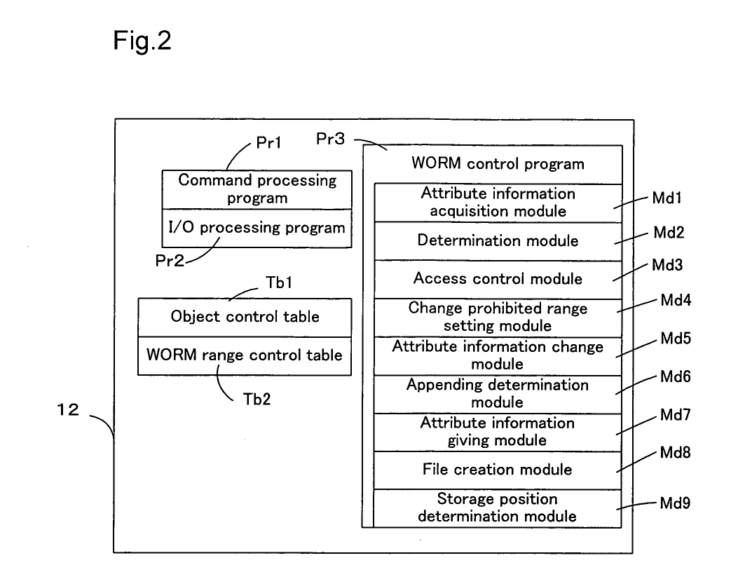

A computer of the first embodiment will be explained with referring to FIGS. 1 and 2. FIG. 1 is an explanatory diagram that shows the schematic structure of a storage system that contains the computer of the first embodiment. FIG. 2 is an explanatory diagram that shows a module that is stored in memory provided with the computer of the first embodiment.

The computer 10 of the first embodiment is a server computer that does not incorporate a storage device that functions as a so-called NAS (Network Attached Storage) head, and this is connected to an external storage device 20 and a network 40. The network 40 is a local area network (LAN) built using the Ethernet (registered trademark), and it executes data transmission using TCP/IP protocol as its communication protocol. Client computers 30, 31, and 32 are connected to network 40 and access the storage device 20 via the computer 10, and utilize the information resources stored in the storage device 20. Moreover, the network 40 may also be connected to an internet 42 via a router 41, and in this case, the computer 10 receives access from the client computers 30 to 31 via the internet 42.

The computer 10 comprises a CPU 11, a memory 12, a rear end I/O interface 13, and a front end I/O interface 14. The CPU 11, memory 12, rear end I/O interface 13, and front end I/O interface 14 are mutually connected via a bus. The CPU 11 is an arithmetic processing device that executes various programs and modules that are stored in the memory 12. The memory 12 is a so-called internal storage device, and includes both non-volatile memory that stores various modules, etc., and volatile memory that temporarily stores arithmetic processing results. The rear end I/O interface 13 is connected to the storage device 20 via a storage area network (SAN), for example. With a SAN, fiber channels and a communication protocol called iSCSI are used. The front end I/O interface 14 is connected to the network 40, and it executes delivering and receiving of commands and data between the client computers 30 through 32 using TCP/IP protocol.

The storage device 20 comprises a disk array controller 21, a connection interface 22, a plurality of disk devices 23, and an I/O interface 24. The disk array controller 21 is a control circuit that executes various control processes for the storage device 20 by executing a control program. The disk array controller 21 is connected to a plurality of the disk devices 23 via connection the interface 22.

The disk device 23 is a disk array device formed from a plurality of magnetic hard disk drives, and provides one or a plurality of logic volumes using a plurality of hard disk drives or provides one or a plurality of logic volumes using one hard disk drive. The I/O interface 24 is connected to the rear I/O interface 13 of the computer 10 via a signal line.

The client computers 30 through 32 are, for example terminal devices for input or output of various types of data, and they execute writing of data to the storage device 20 and reading of data from the storage device 20. Moreover, for the client computers 30 through 32, there can be one item or there can be four or more.

Referring to FIG. 2, the various programs and modules stored in memory 12 will be explained. A command processing program Pr1, an I/O processing program Pr2, a WORM control program Pr3, an object control table Tb1, and a WORM range control table Tb2 are stored in the memory 12. Moreover, various programs and modules operate on a designated operating system.

The command processing program Pr1 is a program that interprets commands received from the client computers 30 through 32 and executes transfer of commands to the command execution module, and for example, determines whether the command to be executed is a data overwrite command, an append command, or a read command.

The I/O processing program Pr2 is a program for controlling sending and receiving of data and commands between the client computers 30 through 32 and the storage device 20.

The WORM control program Pr3 is a program for executing various important controls for this embodiment, and for part or all of files, executes various processes for executing WORM processing that allows read only after write is performed once. The WORM control program Pr3 comprises an attribute information acquisition module Md1, a determination module Md2, a access control module Md3, a change prohibited range setting module Md4, an attribute information change module Md5, an appending determination module Md6, an attribute information giving module Md7, a file creation module Md8, and a storage position determination module Md9.

The attribute information acquisition module Md1 is a module for acquiring the WORM range control table Tb2 via the object control table Tb1 which contains various attributes of a file, for example information regarding the change prohibited range that shows the range for which change is not allowed. The Determination module Md2 is a module for deciding whether the write destination for a file is outside the WORM range described in the WORM range control table Tb2. The access control module Md3 is a module that, when the data write destination for a file is contained in the WORM range, does not execute write of data to a file (storage device 20), and that, when the data write destination for a file is not contained in the WORM range, does execute write of data to a file (storage device 20). The access control module Md3 also, when the write request to a file is an appending request, if appending to files is allowed in the object control table Tb1, executes appending of data to the file, and if appending is not allowed, does not execute appending of data to the file.

The change prohibited range setting module Md4 is a module for setting a WORM range (change prohibited range) for a file. The attribute information change module Md5 is a module that reflects the WORM range set by change the prohibited range setting module Md4 in the WORM range control table Tb2, and that reflects the WORM attributes set by the change prohibited range setting module Md4 in the object control table Tb1. The appending determination module Md6 is a module that determines whether the write request to a file is an appending request. The attribute information giving module Md7 is a module that gives designated WORM attributes to a new file when a new file is generated for a directory for which WORM is set. The file creation module Md8 is a module for creating (opening) new files (object control table Tb1) in a designated directory. The storage position determination module Md9 is a module for deciding whether or not the data write position in a file is outside the storage range of the WORM range described in the WORM range control table Tb2.

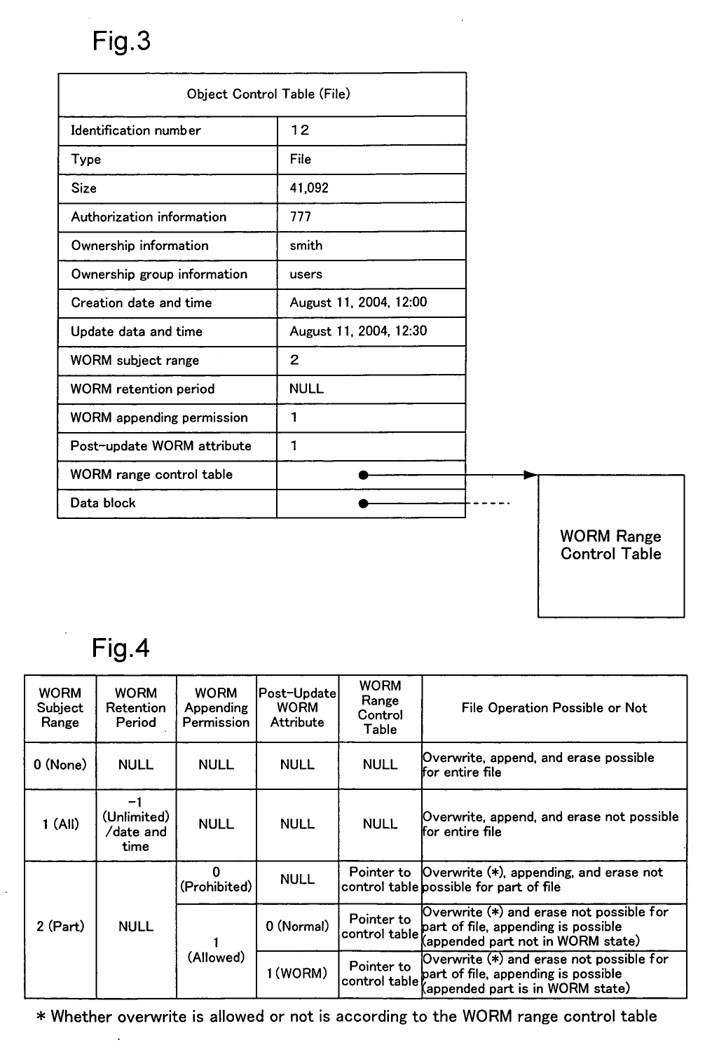

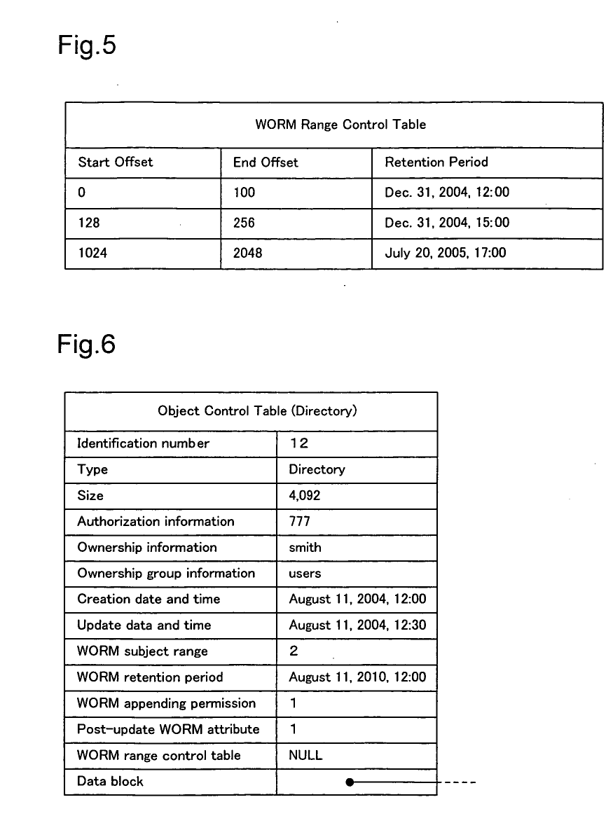

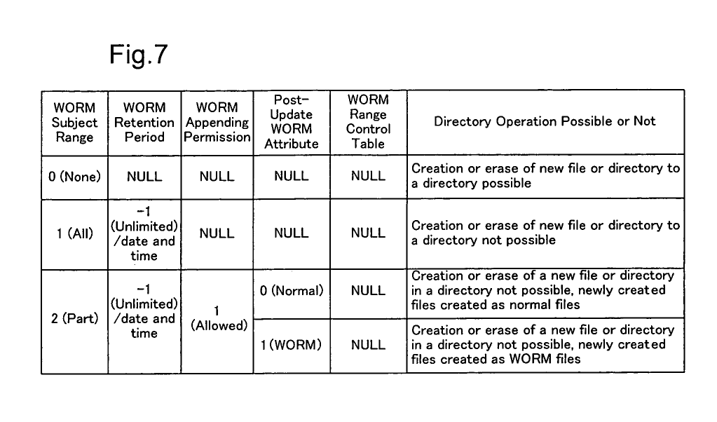

The object control table Tb1 functions as a table that is equipped with a pointer that indicates the data (data blocks) that form a file, or a pointer that indicates a sub directory. The object control table Tb1 and WORM range control table Tb2 will be explained with referring to FIGS. 3 through 7. FIG. 3 is an explanatory diagram that shows an example of object control table Tb1f for files. FIG. 4 is an explanatory figure that shows the correlation of the WORM attribute combination and the possible file operations. FIG. 5 is an explanatory diagram that shows an example of the WORM range control table Tb2. FIG. 6 is an explanatory diagram that shows an example of the object control table Tb1 for directories. FIG. 7 is an explanatory diagram that shows the correlation of the WORM attribute combinations and possible directory operations.

The object control table Tb1f for files shown in FIG. 3 has WORM related attributes including general file attributes of identification numbers for uniquely identifying a file, the types controlled by the object control table, file size, authorization information, ownership information, and creation and update date and times, as well as the WORM subject range that shows whether the portion of a file subject of WORM is All (1), part (2), or None (0), the WORM retention period that shows the set WORM retention period, the WORM appending permission that shows whether appending of a file under WORM state is Allowed (1) or Prohibited (0), and the post-update WORM attribute that shows whether committing appended data to WORM state is to be performed (1) or not performed (0).

The relationship between WORM attribute combinations and possible file operations will be explained with referring to FIG. 4. When the WORM subject range is set to (0), it means that there is no subject range that is subject to WORM in the file, and that like with a normal file, it is possible to do overwrite, append, and erase to the entire file. When the WORM subject range is set to (1), it means that all of the file is subject to WORM, and for the WORM retention period, there is noted either (−1), which indicates no retention, or a specific date. In this case, it is not possible to overwrite, append, or erase to the overall file the same as with a prior art file subject to WORM state.

When the WORM subject range is set to (2), this means that part of files are subject to WORM, and the WORM retention period is stipulated by the WORM range control table Tb2 for each range so is set to NULL. The WORM range control table Tb2 is specified by a pointer to the WORM range control table Tb2 that corresponds to each file. When the WORM appending permission value is (0), since appending is not allowed, it is not possible to overwrite, append, or erase to part of the files (the part subject to WORM). On the other hand, when the WORM appending permission value is (1), though it is not possible to overwrite or erase to the part of the files for which appending is Allowed (the part that is subject to WORM), appending is allowed. Furthermore, in this case, when the post-update WORM attribute value is (0), the appended part is not committed to WORM state, and when the post-update WORM attribute value is (1), the appended part is committed to WORM state.

The object control table Tb1f for files further comprises respectively a pointer to the WORM range control table Tb2 which shows the WORM range of a file and a pointer to the data block that belongs to a file. Each of these pointers, for example, describes a standard value of the logic block address (LBA), for example as an offset value from the value 0. Specifically, each data block or the WORM range control table Tb2 logical storage position (address) for the logic volume is specified by the logic block address and offset value. The specified logic address is converted to a physical address by the disk array controller 21 for the storage device 20, and the physical address (storage position) of a designated disk device 23 is specified. Moreover, when there are multiple data blocks that form one file, it is possible to store multiple offset values to point to multiple data blocks directly, or to store offset values for pointing to multilevel pointer groups for pointing to multiple data blocks indirectly.

The WORM range control table Tb2 shown in FIG. 5 is specified by, of the data that forms a file, the start offset and end offset of the range subject to be committed to WORM state. A retention period is set for each range specified by the start offset and end offset. Even after the retention period ends, overwrite and erase do not become valid immediately, and overwrite and erase first become possible without restriction when WORM attribute cancellation processing is executed.

The Object control table for directories Tb1d shown in FIG. 6 has the same structure as object control table for files Tb1f, and comprises WORM related attributes including general directory attributes of identification numbers for uniquely identifying a directory, the types controlled by the object control table, directory size, authorization information, ownership information, and creation and update date and times, as well as the WORM subject range that shows whether the portion of a directory subject of WORM is All (1), part (2), or None (0), the WORM retention period that shows the set WORM retention period, WORM appending permission that shows whether appending to a file of a directory under WORM format is Allowed (1) or Prohibited (0), and the post-update WORM attribute that shows whether committing data appended to a file in a directory into WORM state is to be performed (1) or not performed (0).

The relationship of WORM attribute combinations and possible directory operations will be explained with referring to FIG. 7. When the WORM subject range is set to (0), it means that there is no WORM subject in the directory, and that like with a normal directory, it is possible to create and erase new files and directories within the directory. When the WORM subject range is set to (1), it means that all of the directory is subject to WORM, and in the WORM retention period, either (−1) that shows no retention or a specific date is noted. In this case, it is not possible to create or erase new files or directories into the directory.

When the WORM subject range is set to (2), this means that part of the directory is subject to WORM, and in the WORM retention period, either (−1) that shows no retention or a specific date is noted. When the subject is a directory, the pointer to the WORM range control table Tb2 that shows the WORM range for a file is invalid (NULL). The WORM appending permission value is set to (1: Allowed), and creation of a new file directory into the directory is possible, but erase is not possible. When the post-update WORM attribute value is (0), normal file attributes are given to files that are newly created inside a directory. On the other hand, when the post-update WORM attribute value is (1), WORM attributes are given to files that are newly created inside a directory.

The Object control table for directories Tb1d is further equipped with pointers that respectively specify sub directories or files contained in the directory. Each of these pointers is described as a reference value of the logic block address (LBA), for example, the offset value from the 0 value. Specifically, the logical storage position (address) of a directory or file in a logic volume is specified by the logic block address and offset value.

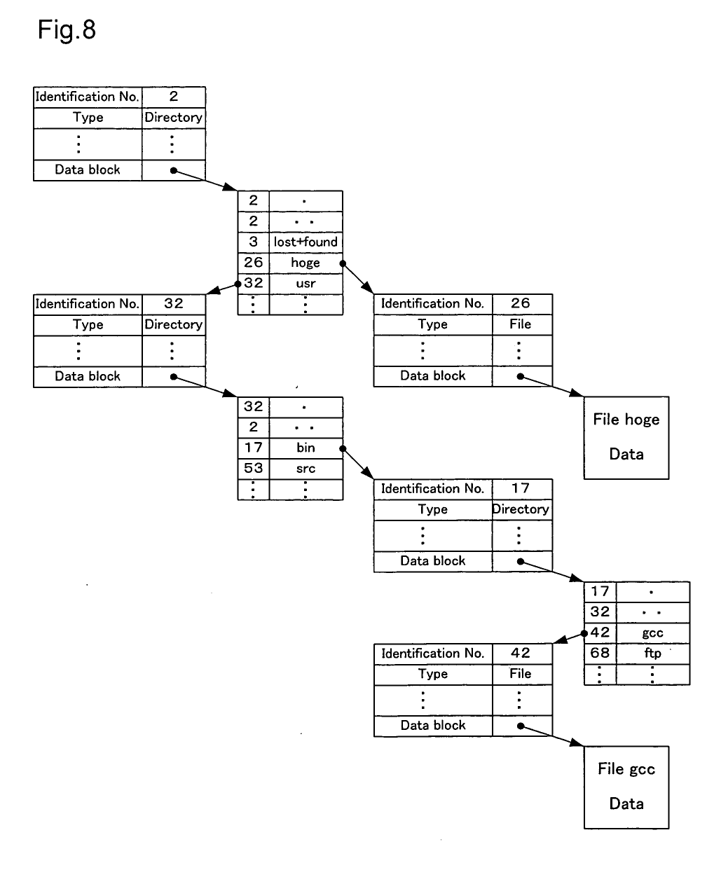

The logic structure of a file system will be explained with referring to FIG. 8. FIG. 8 is an explanatory diagram that shows an example of a file system logic structure. As shown in FIG. 8, when access to the file “hoge” that is within the directory of identification number 2, from the client computers 30 through 32, an identification number for specifying file “hoge”, a file name for specifying the directory in which the file hoge is stored, and the mode (read-only, read-write, etc.) are sent to computer 10 which comprises a file system. When the operating system (OS) of computer 10 succeeds in opening the concerned file, the identification number of the concerned file is returned. Moreover, in the case of a new file, a corresponding object control table is created.

Through the route directory (data block that stores files contained in that directory, the directory name, and a list of pointers that show the object control table Tb1) the computer 10 points to (acquires) the object control table of the applicable identification number based on the specified directory identification number, which is identification number 2 in the example in FIG. 8. Then, according to the object control table of the identification number 2 directory, the corresponding directory data block is pointed to. Pointers to the file hoge object control table (identification number 26) are prepared in the pointed out directory data block, and the identification number 26 object control table is pointed to by the concerned pointers. As already described, the identification number 26 object control table has described pointers to data blocks that store actual data that forms files, so the file “hoge” is specified by the concerned pointers.

Meanwhile, when executing access to file “gcc” that is stored in the identification number 17 sub directory that is in the identification number 2 directory, the directory data block is pointed to by the object control table of the identification number 2 directory, and the object control table of the identification number 32 sub directory is pointed to by the list data. The object control table of the identification number 17 sub directory is pointed to by the object control table of the identification number 32 sub directory, and the object control table (identification number 42) of the file “gcc” is pointed to by the object control table of the identification number 17. The file “gcc” is specified by the pointer to the data block that stores the actual data that forms the file “gcc” that is described in the identification number 42 object control table.

For data write processing for a specified file, in cases when the write subject range is in part of an existing file, or when creating a sparse file for which the start or middle part of a new file is in an empty state, the actual data write processing is executed after performing a seek operation by specifying an identification number and offset. In this case, when writing 1 KB of actual data from the start address to a new file, the size of the file on object control table Tb1 is 1 KB, but, for example, when writing actual data after up to 2 TB seeking was done, the file size becomes 2 TB+1 TB.

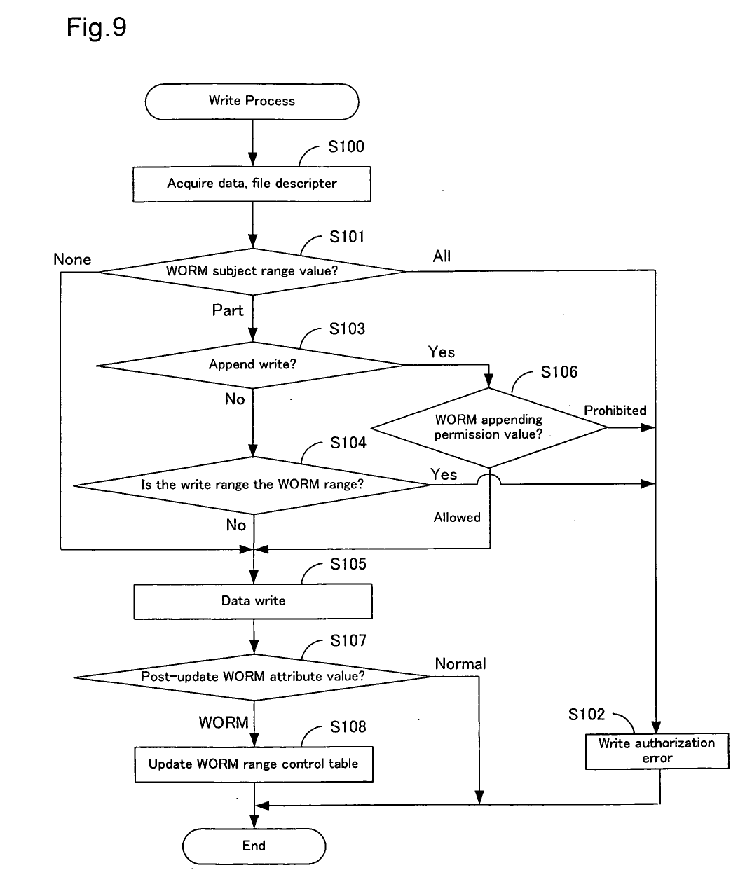

Data write processing for the first embodiment will be explained with referring to FIG. 9. FIG. 9 is a flow chart that shows the process routine of data write processing that is executed by the computer 10 in relation to the first embodiment.

This process is started by having a data write request (command) from the user input to the computer 10 via an input device such as a keyboard or mouse for the client computers 30 through 32, and by the command process program Pr1 and the WORM control program Pr3 being executed by the CPU 11. When a request (command) is received from the client computers 30 through 32, the CPU 11 determines the type of command, and when it is determined that this is a write command, the following write processing is executed.

The CPU 11 acquires the object control table Tb1f of the files for which data should be written (step S100) that corresponds to the data for which write is requested and the file name input from the client computers 30 through 32. The CPU 11 references the acquired object control table Tb1f and determines the WORM determination value (step S101). When the WORM determination value for object control table Tb1f is All (1) (step S101: All), overwrite and appending of data to the overall file is not allowed, so a write authorization error is returned to the client computers 30 through 32 (step S102), and the CPU 11 ends this process routine.

When the WORM determination value for object control table Tb1 is Part (2) (step S101: Part), the CPU 11 determines whether the write request is a request to append the file (step S103). Specifically, it determines whether the write request is a rewrite (overwrite) of existing data that forms a file, or if it is appending to existing data that forms a file. In specific terms, this is determined by whether the start offset value (logic address) for which write is requested is greater than the existing data final offset value (logic address) for the file.

When the CPU 11 determines that the write request is an overwrite request for a file, specifically, that the start offset value is smaller than the file size (step S103: No), the CPU 11 determines whether the data write subject range is contained in the WORM range (step S104). In specific terms, the CPU 11 references the WORM range control table Tb2 that is pointed to by object control table Tb1f of the file that is a subject, and determines whether the data write subject range overlaps the WORM range. In light of this, the write subject range is stipulated by the start offset value and the write end offset value that is set by the data size, and the WORM range is stipulated by the start offset value to end offset value in the WORM control table Tb2.

When the CPU 11 determines that the write subject range is not contained in the WORM range (step S104: No), the CPU 11 performs data write (step S105). In specific terms, the CPU 11 gives instructions to the disk array controller 21 of the storage device 20 to write data to the disk device 23, and updates the pointers for the object control table Tb1f. The disk array controller 21 that has received write instructions from the CPU 11 converts the instructed logical write subject range (address) to a physical write subject range (address), executes data (data block) write to the disk device 23, and records the correlation of this in the address conversion table.

When the CPU 11 determines that the write subject range is contained in the WORM range (step S104: Yes), data overwrite is not allowed in relation to the WORM range, so a write authorization error is returned to the client computers 30 through 32 (step S102), and this process routine is ended. There are two examples for which the write subject range is contained in the WORM range, one when write is an overwrite to an entire file, and a second when write is an overwrite to part of a file, but the subject write range is set to WORM state.

At step S103, when the CPU 11 determines that the write request is an appending request (step S102: Yes), CPU 11 references the object control table Tb1f determines the WORM appending permission value (step S106). When the CPU 11 determines that the WORM appending permission value for object control table Tb1f is Prohibited (0) (step S106: No), appending to the subject file is not allowed, so a write authorization error is returned to client computers 30 through 32 (step S102), and this process routine is ended.

When the CPU 11 determines that the WORM appending permission value for the object control table Tb1f is Allowed (1) (step S106: Yes), a step moves to step S105, and executes writing of appended data to the file. In specific terms, the CPU 11 gives instructions to the disk array controller 21 of the storage device 20 to write data to the disk device 23 and appends to the object control table Tb1f a pointer to the appended data (data block).

When data write is ended, the CPU 11 references the object control table Tb1f of the subject file and determines the post-update WORM value (step S107). When the post-update WORM value for the object control table Tb1f is WORM (1) (step S107: WORM), the CPU 11 performs an update of the WORM range control table Tb2 to perform WORM setting for part of the file or the data appended to the file (step S108), and ends this process routine.

For updating of the WORM range control table Tb2, the start offset value and end offset value of part of the file or data appended to the file are appended to the WORM range control table Tb2, and as a retention period for the appended WORM range, a retention period for the file creation time is noted. Moreover, as described later, it is possible to extend the retention period.

When the post-update WORM value for the object control table Tb1f is Normal (0) (step S107: Normal), the CPU 11 ends this process routine without committing the part of the file or data appended to a file to WORM state, in other words, as normal data.

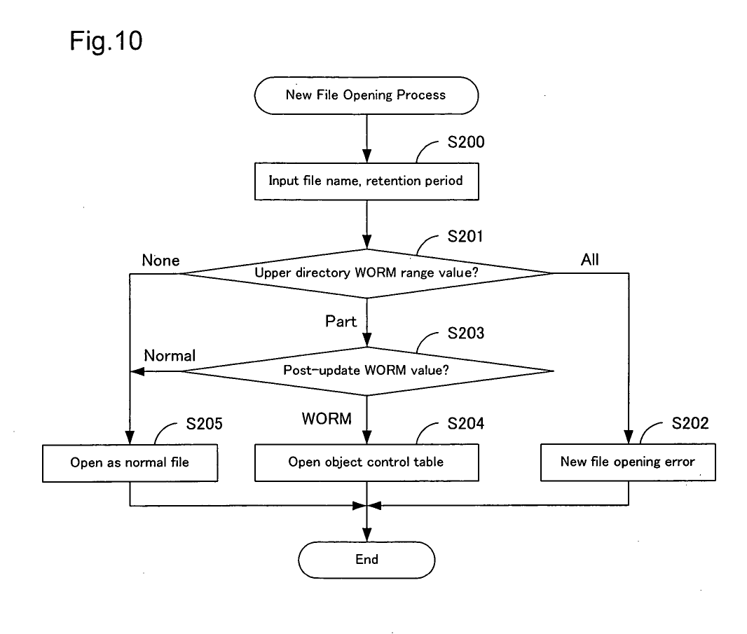

New file opening processing for the first embodiment will be explained with referring to FIG. 10. FIG. 10 is a flow chart that shows the process routine of new file opening processing executed by the computer 10 of the first embodiment.

This process is started by a new file creation (open) request being input to the computer 10 from the user via an input device such as a keyboard or mouse for the client computers 30 through 32, and by the command process program Pr1 and the WORM control program Pr3 being executed by the CPU 11. When a request (command) is received from the client computers 30 through 32, the CPU 11 judges the type of command, and when CPU 11 judges that this is a file opening command, it executes the following file opening process.

The CPU 11 receives input of the file name and retention period (step S200), and when the upper directory to which the file is related, in other words, the directory created by the file, or the file creation directory, is a sub directory, the CPU 11 references the upper directory object control table Tb1d and determines the WORM determination value (step S201). Here, the file name is a required input item, but for files for which WORM is not set, the retention period is not necessarily a required input item.

When the WORM determination value for the upper directory object control table Tb1d is All (1) (step S201: All), creation of new files into an upper directory is not allowed, so the CPU 11 issues the status of the new file open error which is returned to the client computers 30 through 32 (step S202), and ends this process routine.

When the WORM determination value for the upper directory object control table Tb1d is Part (2) (step S201: Part), the CPU 11 determines the post-update WORM value for the upper directory object control table Tb1d (step S203). When the post-update WORM value for the upper directory object control table Tb1d is WORM (1) (step S203: WORM), newly created files are created as WORM files, so the CPU 11 opens an object control table Tb1f for the new file (step S204), and ends this process routine.

The initial value of the object control table Tb1f for the new file is set to WORM subject range: Part (2), WORM appending allowed: Allowed (1), and post-update WORM attribute: WORM (1). Also, when there is retention period input for the retention period, the input retention period is set, and when there is no retention period input, the retention period stipulated in the upper directory is transferred.

When the post-update WORM value for the upper directory object control table Tb1d is Normal (0) (step S203: Normal), newly created files are created as normal files, so the CPU 11 opens newly created files as normal files (step S205) and ends this process routine.

When the WORM determination value for the upper directory object control table Tb1d is None (0) (step S201: None), newly created files are created as normal files, so the CPU 11 opens newly created files as normal files (step S205), and ends this process routine.

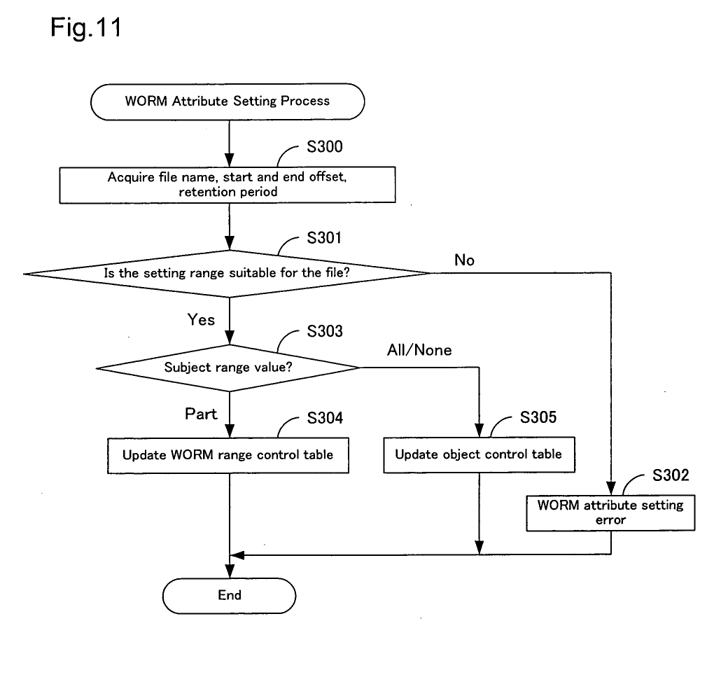

The WORM attribute setting process for the first embodiment will be explained with referring to FIG. 11. FIG. 11 is a flow chart that shows the process routine for the WORM attribute setting process executed by the computer 10 of the first embodiment.

This process is started by input to the computer 10 of a request from a user for committing an existing file to WORM state via an input device such as a keyboard or mouse, etc. on client computers 30 through 32, for example, and by the CPU 11 executing the command process program Pr1 and the WORM control program Pr3. When a request (command) is received from the client computers 30 through 32, the CPU 11 judges the command type, and when CPU 11 judges the command is a WORM attribute setting command, CPU 11 executes the following WORM attribute setting process.

The CPU 11 acquires the name of the file subject to setting, the file subject range (start and end offset), and the retention period from the client computers 30 through 32 (step S300), and determines whether the WORM setting range is suitable for the file (step S301). In specific terms, it is determined whether the input file subject range (offset range) is smaller than the subject file size (offset range). Moreover, free input of the retention period is allowed.

When the CPU 11 determines that the WORM setting range is not suitable for the file, specifically, when the input offset range is greater than the subject file size (step S301: No), it is not possible to execute the process thereafter, so the CPU 11 returns a WORM attribute setting error to the client computers 30 through 32 (step S302) and ends this process routine.

When the CPU 11 determines that the WORM setting range is suitable for a file, specifically, when CPU 11 determines that the input offset range is smaller than the subject file size (step S301: Yes), CPU 11 references the subject file's object control table Tb1f and determines the WORM subject range value (step S303). When the CPU 11 determines that the WORM subject range value is Part (2) (step S303: Part), CPU 11 updates WORM range control table Tb2 and ends this process routine. In specific terms, the input offset range is described to WORM range control table Tb2, and when the retention period is input, CPU 11 describes the input retention period as the retention period, and when a retention period has not been input, CPU 11 notes Unlimited (−1) as the retention period.

When the CPU 11 determines that the WORM subject range value is All (1) or None (0) (step S303: All/None), CPU 11 updates object control table Tb1f and ends this process routine. In specific terms, in the object control table Tb1f, the WORM subject range is changed to part (2), the WORM appending permission is changed to Allowed (1), and the post-update WORM attribute is changed to WORM (1). Also, the input offset range is described in the WORM range control table Tb2, and when a retention period is input, the input retention period is described as the retention period, and when a retention period has not been input, Unlimited (−1) is described as the retention period.

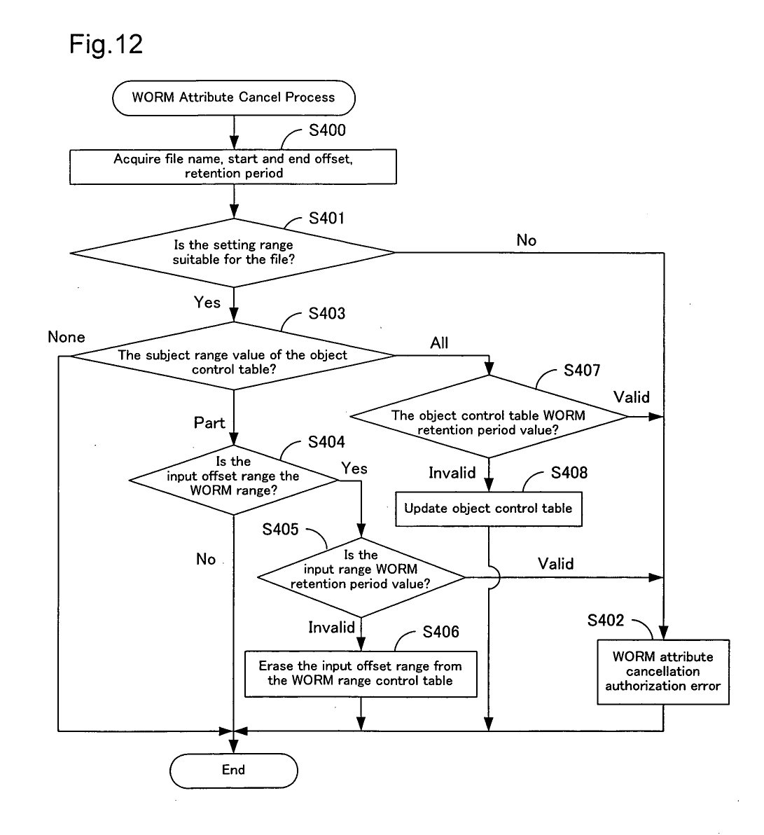

The WORM attribute cancellation processing for the first embodiment will be explained with referring to FIG. 12. FIG. 12 is a flow chart that shows the process routine of the WORM attribute cancellation processing that is executed by the computer 10 of the first embodiment.

This process is started by input from the user to the computer 10 of a request to cancel WORM attributes for an existing file via an input device such as a keyboard or mouse to the client computers 30 through 32, for example, and by the CPU 11 executing command process program Pr1 and the WORM control program Pr3. When a request (command) is received from the client computers 30 through 32, the CPU 11 judges the command type, and when it judges that this is a WORM attribute cancellation command, it executes the following WORM attribute cancellation process.

The CPU 11 acquires the name of the file subject to settings, the file subject range (start and end offset), and the retention period from the client computers 30 through 32 (step S400), and determines whether the WORM cancellation range is suitable for the file (step S401). In specific terms, it is determined whether the input file subject range (offset range) is smaller than the subject file size (offset range). Moreover, free input of the retention period is allowed.

When the CPU 11 determines that the WORM cancellation range is not suitable for the file, specifically, when the input offset range is greater than the subject file size (step S401: No), it is not possible to execute the process thereafter, so the CPU 11 returns a WORM attribute cancellation error to the client computers 30 through 32 (step S402) and ends this process routine.

When the CPU 11 determines that the WORM cancellation range is suitable for a file, specifically, when CPU 11 determines that the input offset range is smaller than the subject file size (step S401: Yes), CPU 11 references the subject file's object control table Tb1f and determines the WORM subject range value (step S403).

When the CPU 11 determines that the WORM subject range value is None (0) (step S403: None), WORM attributes are not set to the subject file, so it ends this process routine.

At step S403, when the CPU 11 determines that the WORM subject range value is Part (2) (step S403: Part), CPU 11 references the WORM range control table Tb2 and determines whether the input offset range is contained in the WORM range (step S404). When the CPU 11 determines that the input offset range is not contained in the WORM range (step S404: No), the WORM range to be cancelled does not exist, so CPU 11 ends this process routine.

When the CPU 11 determines that the input offset range is contained in the WORM range (step S404: Yes), CPU 11 determines the WORM range retention period value that corresponds to the input offset range. When the CPU 11 determines that the WORM range retention period value corresponding to the input offset range is Valid (step S405: Valid), CPU 11 returns a WORM attribute cancellation authorization error to the client computers 30 through 32 (step S402), and ends this process routine. Specifically, for this embodiment, when the retention period is valid, it is not possible to cancel the WORM attributes.

When the CPU 11 determines that the WORM range retention period corresponding to the input offset range is Invalid (step S405: Invalid), CPU 11 removes the input offset range from the WORM range control table Tb2 (step S406), and ends this process routine.

At step S403, when the CPU 11 determines that the subject range value is All (1) (step S403: All), CPU 11 determines the WORM retention period value of the object control table Tb1f (step S407). When the CPU 11 determines that the WORM retention period value is Valid (step S407: Valid), CPU 11 returns a WORM attribute cancellation authorization error to the client computers 30 through 32 (step S402), and ends this process routine. Specifically, as has already been described, for this embodiment, when the retention period is valid, it is not possible to cancel the WORM attribute.

When the CPU 11 determines that the WORM retention period value is Invalid (step S407: Invalid), CPU 11 updates the object control table Tb1f (step S408), and ends this process routine. In specific terms, the WORM subject range in object control table Tb1f is changed to Part (2), the retention period is changed to NULL, and the file range other than the input offset range is described in the WORM range control table Tb2. When a retention period has been input for the retention period of the WORM range control table Tb2, the input retention period is set, and when one has not been input, the retention period that was described in the object control table Tb1f is transferred.

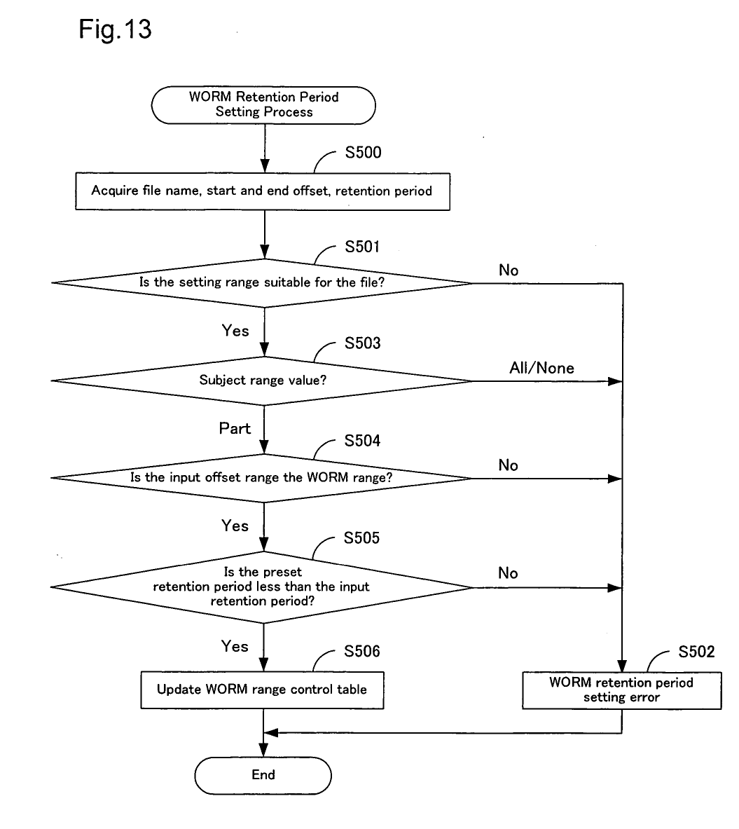

The WORM retention period setting process for the first embodiment will be explained with referring to FIG. 13. FIG. 13 is a flow chart that shows the process routine of a WORM retention period setting process executed by the computer 10 of the first embodiment.

This process is started by a request for a WORM retention period to be set for an existing file being input from a user to the computer 10 via an input device such as a keyboard or mouse, etc. at the client computers 30 through 32, and by the command process program Pr1 and the WORM control program Pr3 being executed by the CPU 11. When a request (command) is received from the client computers 30 through 32, the CPU 11 judges the command type, and when the CPU 11 judges that this is a WORM retention period setting command, the CPU 11 executes the following WORM retention period setting process.

The CPU 11 acquires the name of the file subject to setting, the file subject range (start and end offset), and retention period from the client computers 30 through 32 (step S500), and determines whether the WORM retention period setting range is suitable for the file (step S501). In specific terms, CPU 11 determines whether the input file subject range (offset range) is less than the subject file size (offset range).

When the CPU 11 determines that the WORM retention period setting range is not suitable for the file, specifically, when the input offset range is larger than the subject file size (step S501: No), it is not possible to do the processing thereafter, so the CPU 11 returns a WORM retention period setting error to the client computers 30 through 32 (step S502), and ends this process routine.

When the CPU 11 determines that the WORM retention period setting range is suitable for a file, specifically, that the input offset range is smaller than the subject file size (step S501: Yes), the CPU 11 references the subject file's object control table Tb1f and determines the WORM subject range value (step S503).

When the CPU 11 determines that the WORM subject range value is All (1) or None (0) (step S503: All/None), CPU 11 returns a WORM retention period setting error to the client computers 30 through 32, and ends this process routine. Specifically, when the WORM subject range is all, changing of the retention period once it has been set is not allowed, and on the other hand, when the WORM subject range is none, this is because the retention period is a NULL item.

When the CPU 11 determines that the WORM subject range value is Part (2) (step S503: Part), CPU 11 determines whether the input offset range matches the WORM range (step S504). In specific terms, the CPU 11 references the WORM range control table Tb2 via the subject file's object control table Tb1f, and determines whether the input offset range matches the set WORM range.

When the CPU 11 determines that the input offset range does not match the WORM range (step S504: No), CPU 11 returns a WORM retention period setting error to the client computers 30 through 32 (step S502), and ends this process routine. Specifically, when the input offset range does not match the WORM range, this is because the input offset range it not a suitable offset range for the subject file.

When the CPU 11 determines that the input offset range matches the WORM range (step S504: Yes), CPU 11 determines whether the preset retention period is newer than the input retention period (step S505). In specific terms, the CPU 11 references the WORM range control table Tb2 and makes a determination using the input retention period and the WORM range retention period that corresponds to the input offset range.

When the CPU 11 determines that the input retention period is older than the preset retention period (step S505: No), CPU 11 returns a WORM retention period setting error to the client computers 30 through 32 (step S502) and ends this process routine. Specifically, with this embodiment, this is because changes that shorten the retention period are not acknowledged, and only changes that extend the retention period are acknowledged.

When the CPU 11 determines that the input retention period is newer than the preset retention period (step S505: Yes), CPU 11 updates the WORM range control table Tb2, and ends this process routine. In specific terms, the CPU 11 sets the WORM range retention period that corresponds to the input offset range to the input retention period in the WORM range control table Tb2.

As explained above, with the computer 10 of the first embodiment, the WORM range is described using offset units in the WORM range control table Tb2, and it is possible to set a change prohibited range (WORM range) not only for an entire file but also for part of a file. Therefore, it is possible to create WORM files that allow flexible overwrite according to the file use format. For example, it is possible to append data to a change prohibited (committed to WORM state) file.

It is also possible to set a change prohibited range for a file using partial units, so it is possible to commit data to WORM state in sequence from the parts (data) written to a file. As a result, for example, as with log files, it is possible as needed to commit data to WORM state the appended parts each time appending is done for files of the appended type as well, and it is possible to protect data from inadvertent overwrite and erase.

Furthermore, by giving a WORM attribute to a directory, it is possible to commit a newly created file data to WORM state simultaneously with creation. Also, for existing files created as normal files, it is possible to commit files to WORM state using designated units such as data blocks units, for example.

At the same time as being able to cancel a WORM attribute for existing WORM files, it is possible to extend the retention period. Moreover, when a WORM attribute is cancelled for an existing WORM file, a condition is that the retention period is exceeded (is invalid), so it is possible to protect data without changing data for which the WORM attribute has been cancelled before a retention period that has been set.

### Second Embodiment

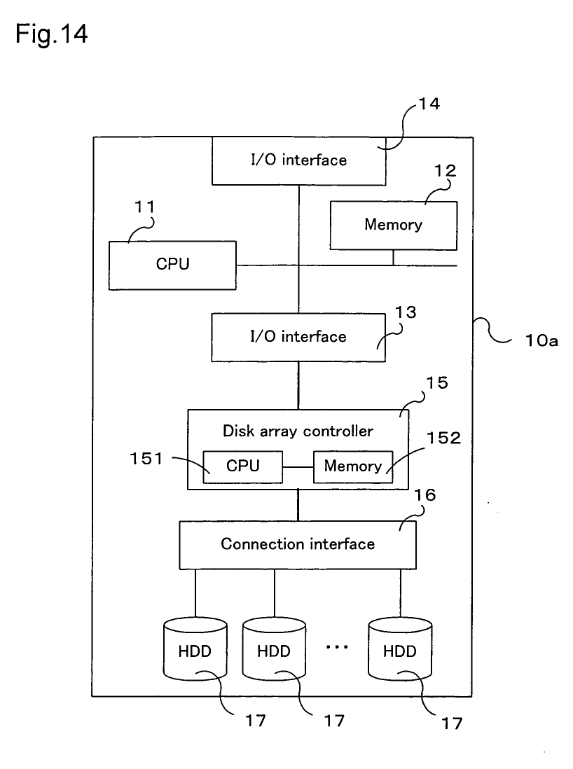

Computer 10a of the second embodiment will be explained with referring to FIG. 14. FIG. 14 is an explanatory diagram that shows the schematic structure of a storage system that contains the computer of the second embodiment. The computer 10a of the second embodiment functions as a computer server computer that incorporates the storage device 20, a so-called NAS.

The Computer 10a comprises a CPU 11, a memory 12, a rear end I/O interface 13, a front end I/O interface 14, a disk array controller 15, a connection interface 16, and a plurality of disk devices 17. The CPU 11, memory 12, rear end I/O interface 13, and front end I/O interface are mutually connected via a bus. The rear I/O interface 13 is connected with the disk array controller 15, and access commands from the CPU 11 to the disk device 17 are executed by the disk array controller 15.

The disk array controller 15 executes data write and data read for a plurality of the disk devices 17 via the connection interface 16 by executing a control program according to commands received from the CPU 11.

The WORM control program Pr3 explained in the first embodiment is executed in the same way for the second embodiment and the same effects and actions can be obtained.

As explained above, the computer 10a of the second embodiment can set a partial WORM range for a file and realize appending to a WORM file for a NAS server computer equipped with a disk array device formed from a plurality of disk devices.

### Other Embodiments

(1) Each of the WORM attribute item setting values of the file object control table Tb1f of the first embodiment during file opening or during updating of file object control table Tb1f are examples, and it is also possible to set other setting values. For example, during file opening, appending is set to Prohibited (0), and post-update WORM attributes are set to Normal (0), and it is also possible to change these WORM attributes later.

(2) With the first embodiment, as an example, one storage device 20 is connected to the computer 10, but it is also possible to have the computer 10 connected to a storage area network (SAN) composed from a plurality of storage devices. Also, the computer 10 can also be connected 1-to-1 via a single storage device and a dedicated line. As the communication protocol for the dedicated line, it is possible to use fiber channels or iSCSI, for example.

(3) With the second embodiment, the WORM control program Pr3 is executed by the CPU 11 of the computer 10a, but it can also be executed by the disk array controller 15. Specifically, it is also possible to store the WORM control program Pr3, object control table Tb1, and WORM range control table Tb2 on memory 152 which comprises the disk array controller 15, and to have the WORM control program Pr3 executed by the CPU 151 which comprises the disk array controller 15.

(4) With the embodiments noted above, writing to files that are committed to WORM state is explained, but in terms of reading, regardless of the WORM range setting, it goes without saying that it is possible to read designated data as needed.

(5) With the embodiments noted above, the WORM control process is executed using a WORM control processing program, but it is also possible to execute using a WORM control processing hardware circuit equipped with a logic circuit that executes each of the aforementioned processes (steps). In this case, it is possible to reduce the load on the CPU 11 and also to be able to realize higher speed processing.

As mentioned above, a computer of the present invention, a control method for storage devices, and a control program for storage devices based on embodiments, but the working embodiments of the invention noted above are for making the present invention easy to understand, but they do not limit the present invention. The present invention of course can be obtained with changes and improvements without straying from the gist and scope of the invention and the present invention can also include equivalent items.

What is claimed is:

1. A computer that controls access to files stored in a storage device, said computer comprising:
an attribute information acquisition module that, when there is a request to write data to said file stored in said storage device, acquires attribute information that contains at least information regarding the change prohibited range that shows the range for which changes to a file are not allowed, which is information associated with said file;
a determination module that determines whether the subject range of writing data to said file is a range outside said change prohibited range by referencing said acquired attribute information; and
an access control module that, when the determination module determines that the subject range of writing data to said file is contained in said change prohibited range, does not execute writing of data to said file.

2. A computer of claim 1 wherein
said access control module, when the determination module determines that the subject range of writing data to said file is not contained in said change prohibited range, executes writing of data to said file.

3. A computer of claim 2, further comprising:
a change prohibited range setting module that, when writing of data to said file is executed, sets the change prohibited range that does not allow changes for the subject range for said file,
and an attribute information change module that reflects said set change prohibited range in said attribute information.

4. A computer of claim 1, further comprising:
a change prohibited range setting module that sets said change prohibited range for which changes are not allowed for said file,
and an attribute information change module for which said set change prohibited range is reflected in said attribute information.

5. A computer of claim 1, further comprising:
an appending determination module that determines whether a request to write data to said file is an appending request,
wherein said attribute information further contains appending permission information that shows whether appending data to a file is permitted,
and said access control module, when it is determined that the a request to write data to said file is an appending request, and that the subject range of writing data to said file is not contained in said change prohibited range, and further when said appending permission information of said file shows that appending to said file is permitted, executes appending of data to said file.

6. A computer of claim 5, further comprising:
a change prohibited range setting module that, when data is appended to said file, sets the change prohibited range to not allow changes to the subject range for said file,
and an attribute information change module for which said set change prohibited range is reflected in said attribute information.

7. A computer of claim 1 wherein
said storage device has a directory that contains one or a plurality of said files,
said directory is correlated to directory attribute information that shows whether changes are allowed for said one or plurality of files contained in the directory,
and said computer further comprises:
an attribute information giving module that, when a new file is generated for a directory for which said directory attribute information shows said change is not allowed, gives said attribute information to said newly generated file.

8. A computer of claim 1, further comprising:
an attribute information storage unit that stores said attribute information,
and wherein said attribute information acquisition module acquires said attribute information which is correlated to said file from said attribute information storage unit.

9. A computer of claim 1,
wherein said storage device is composed from a plurality of storage disks and is placed inside said computer.

10. A computer of claim 1,
wherein said storage device is composed from a plurality of storage disks and is placed outside said computer.

11. A computer that controls access to a storage device, said computer comprising:
a file creation module that creates files in said storage device;
a data writing module that writes data to said created file; and
a setting module that, for each data write to said file, sets change prohibition so that data is not allowed to be changed for said written data storage position for said file.

12. A computer that controls access to a storage device, said computer comprising:
a file creation module that creates a file at said storage device, wherein the file is composed from one or a plurality of data and has one or plurality of data storage position information at said storage device as well as identification information for said storage device;
a storage unit that stores attribute information that is information correlated to said file and that contains at least change prohibition information that shows said data storage positions for which change is not allowed for the file;
a receiving module that receives access request commands for said storage device;
a command determination module that determines whether said received access request command is a request to write data to said storage device;
a storage position determination module that, when said received access request command is a request to write data to said storage device, specifies a file to be subject to data write using said identification information, acquires said attribute information from said storage unit, and determines whether the data write position in relation to said file overlaps with said storage position that is contained in said change prohibited information; and
an access control module that, when it is determined that the data write position in relation to said file overlaps said storage position contained in said change prohibited information, does not execute data write to said file.

13. A computer of claim 12, wherein
said access control module, when it is determined that the data write position in relation to said file does not overlap said storage position contained in said change prohibited information, as well as when said data write position is larger than the final storage position of data that forms said file which is described in said data storage position information, executes data write as appending processing to said file,
and wherein said computer further comprises a change prohibited range setting module that sets from said data's said write position to the write completion position as a storage position for which change is not allowed,
and an attribute information change module for which said set change prohibited range is reflected in said attribute information.

14. A computer of claim 12, wherein
said access control module that, when it is determined that the data write position in relation to said file does not overlap said storage position contained in said change prohibited information, as well as when said data write position is smaller than the final storage position of data that forms said file which is described in said data storage position information, executes data write as overwrite processing to said file.

15. A method of controlling access to files stored in a storage device, the control method comprising:
acquiring attribute information, wherein the attribute information is correlated to said file, and contains at least information regarding a change prohibited range that shows the range for which change is not allowed for a file, when a request for data write to said file stored in said storage device has been issued;
determining whether the subject range for data write in relation to said file is a range that is outside said change prohibited range by referring said acquired attribute information; and
executing data write to said file when it is determined that the subject range of data write in relation to said file is contained in said change prohibited range.

16. A method of controlling access to a storage device, the control method comprising:
creating a file at said storage device, wherein the file is composed from one or a plurality of data and has said one or plurality of data storage position information for said storage device as well as identification information for said storage device;
receiving access request commands for said storage device;
acquiring attribute information, wherein the attribute information is correlated to said file, and contains at least change prohibited range information that shows said data storage position for which change is not allowed for the file, when it is determined that said received access request command is a request to write data to said storage device;
specifying a file to be subject to data write using said identification information;
determining whether the data write position in relation to said file overlaps with said storage position that is contained in said change prohibited information in the acquired attribute information; and
not executing data write to said file when it is determined that the data write position in relation to said file overlaps said storage position contained in said change prohibited information.
